(19) United States
(12) Patent Application Publication
(10) Pub. No.: US 2020/0377289 A1
(43) Pub. Date: Dec. 3, 2020

(54) PACKAGING MEMBER FOR CLEANING BLADES

(71) Applicant: SYNZTEC CO., LTD., Tokyo (JP)

(72) Inventors: Shuang WANG, Kanagawa (JP); Atsuo HASHIME, Kanagawa (JP); Shuji ABE, Kanagawa (JP); Hiroyuki SATO, Kanagawa (JP)

(21) Appl. No.: 16/947,856

(22) Filed: Aug. 20, 2020

Related U.S. Application Data
(62) Division of application No. 15/771,234, filed on Apr. 27, 2018.

(30) Foreign Application Priority Data
Oct. 26, 2015 (JP) 2015-210194

(51) Int. Cl. B65D 85/68; B65D 85/20; G03G 21/00; B65D 57/00; B65D 21/02

(52) U.S. Cl. CPC B65D 85/68; B65D 85/20; G03G 21/00; G03G 21/0011; B65D 2585/689; B65D 21/0212; G03G 21/0029; G03G 2221/1807; B65D 57/003

(57) ABSTRACT

A packaging member for cleaning blades each having a blade main body and a holder part comprises at least one set of packaging member main bodies for supporting, respectively, opposite ends and of the holder parts of the cleaning blades. A first packaging member main body which is one of the set of packaging member main bodies has a plurality of first support parts disposed at predetermined intervals along the longitudinal direction of the packaging member main body. The first support parts each support one end portion of the holder part. A second packaging member main body which is the other of the set of packaging member main bodies has a plurality of second support parts disposed at the predetermined intervals along the longitudinal direction of the packaging member main body. The second support parts each support the other end portion of the holder part.

### TECHNICAL FIELD

The present invention relates to a packaging member for cleaning blades to be incorporated in image forming apparatus, such as electrophotographic copiers and printers and toner-jet copiers and printers.

### BACKGROUND ART

Generally, an electrophotographic process performs at least a cleaning process, an electric charging process, an exposure process, a development process, and a transfer process on an electrophotosensitive medium. These processes use a cleaning blade for removing remaining toner from the surface of a latent image carrier such as a photosensitive drum to clean the surface, an electrically conductive roller for imparting a uniform electrical charge to the photosensitive medium, a transfer belt for transfer of a toner image, etc. The cleaning blade is usually composed of a rectangular blade body which is brought into slide contact with the surface of the photosensitive drum, and a support member (also called a holder member) for supporting the blade body at a non-slide-contact portion.

Meanwhile, in packaging cleaning blades of such a type, there have been used a thin resin tray composed of a recessed storage part for storing blade bodies of the cleaning blades, and a convexed fixing part for fixing support members of the cleaning blades, a tubular storage case formed according to the cleaning blades, and like packaging members (see, for example, Patent Document 1). These packaging members can protect the cleaning blades from vibration, shock, etc.

However, since the resin tray is formed from thin resin, a tray having enhanced load bearing performance is demanded. Also, since the resin tray stores the cleaning blades such that they are arrayed horizontally, a single resin tray can store a few cleaning blades only due to the restriction of space. Further, due to low storage rate for cleaning blades, packaging work requires a large number of resin trays; therefore, improvement of work efficiency and cost performance has been desired. Also, since the above-mentioned resin tray is apt to be deformed or broken, reuse of the resin tray is difficult, and disposal of resin tray wastes may increase environmental load and may deteriorate cost performance. Further, since the above-mentioned resin tray is fabricated in accordance with the shape of the cleaning blade in question, the resin tray encounters difficulty in application to cleaning blades having other shapes; thus, a highly versatile packaging member has been desired.

Similar to the case of the above-mentioned resin tray, the above-mentioned storage case also involves concern about storage performance, storage workability, cost performance, reusability, and versatility.

### PRIOR ART DOCUMENT

### Patent Document

Patent Document 1: Japanese Utility Model Application Laid-Open (kokai) No. S63-011669

### SUMMARY OF THE INVENTION

### Problem to be Solved by the Invention

The present invention is proposed in view of the above problem involved in the conventional technique, and an object of the invention is to provide a packaging member allowing reuse and exhibiting excellent cost performance and versatility, and an improved storage rate.

### Means for Solving the Problem

A packaging member for cleaning blades according to an embodiment of the present invention for solving the above problem is a packaging member for cleaning blades each having a blade body which is brought into slide contact with a surface of a latent image carrier, and a holder part for supporting a non-slide-contact portion of the blade body, comprising at least a set of packaging member main bodies for supporting opposite end portions of the holder parts of the cleaning blades. The packaging member for cleaning blades is characterized in that a first packaging member main body which is one of the set of packaging member main bodies has a plurality of first support parts disposed at predetermined intervals along a longitudinal direction thereof and adapted to support respective one end portions of the holder parts and that a second packaging member main body which is the other of the set of packaging member main bodies has a plurality of second support parts disposed at predetermined intervals along the longitudinal direction thereof and adapted to support respective other end portions of the holder parts.

The packaging member for cleaning blades according to the above embodiment may be configured such that the first packaging member main body and the second packaging member main body are common members and such that each of the first packaging member main body and the second packaging member main body has the first support parts or the second support parts disposed at one edge portion in a lateral direction orthogonal to the longitudinal direction and has the first support parts or the second support parts disposed at the other edge portion in the lateral direction.

The packaging member for cleaning blades according to the above embodiment may be configured such that the first support parts and the second support parts are grooves.

The packaging member for cleaning blades according to the above embodiment may be configured such that each of the holder parts has holes extending therethrough in a thickness direction thereof and formed at respective opposite end portions thereof and such that the first support parts and the second support parts have respective insertion protrusions which are inserted into the holes.

The packaging member for cleaning blades according to the above embodiment may be configured such that each of the first packaging member main body and the second packaging member main body has a structure which allows stacking thereof in a vertical direction.

The packaging member for cleaning blades according to the above embodiment may be configured as follows: each of the first packaging member main body and the second packaging member main body has engagement portions at respective longitudinal opposite end portions for allowing stacking in the vertical direction, and each of the engagement portions has an engagement protrusion formed on an upper surface thereof and has an engagement recess formed in a lower surface thereof for engagement with the engagement protrusion.

The packaging member for cleaning blades according to the above embodiment may be configured such that each of the first packaging member main body and the second packaging member main body has recesses formed in a lower surface thereof for avoiding interference with the holder parts of the cleaning blades supported by the first support parts and the second support parts.

The packaging member for cleaning blades according to the above embodiment may be configured such that the packaging member comprises a first packaging member consisting of the set of packaging member main bodies, and a second packaging member to be stacked on the first packaging member and consisting of another set of packaging member main bodies and such that the longitudinal positions of the first support parts and the second support parts of the first packaging member differ from the longitudinal positions of the support parts of the second packaging member.

### Effects of the Invention

The present invention can implement a packaging member for cleaning blades allowing reuse and exhibiting excellent cost performance and versatility, and an improved storage rate.

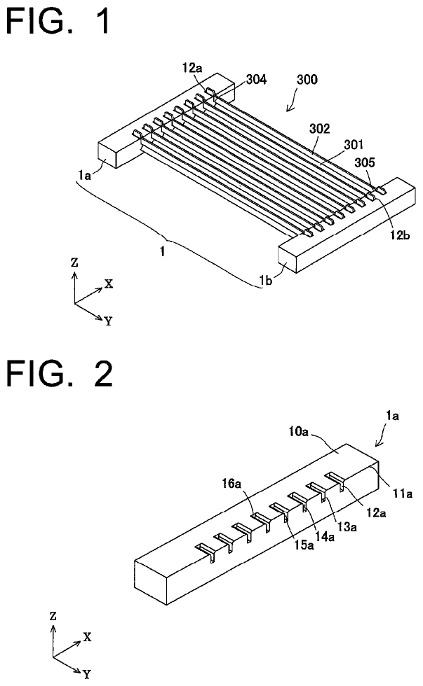

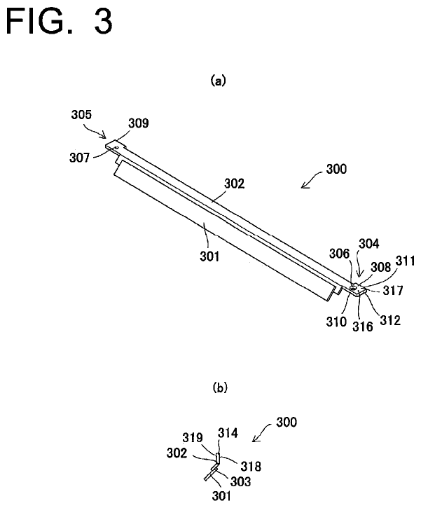

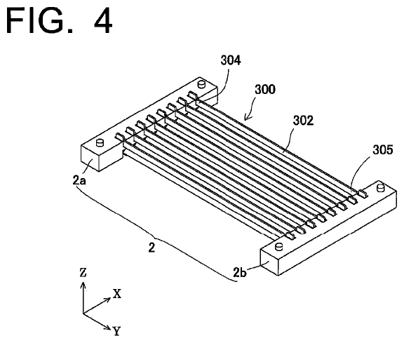

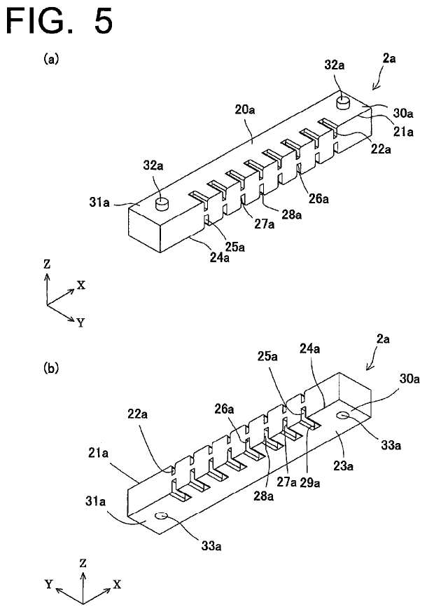

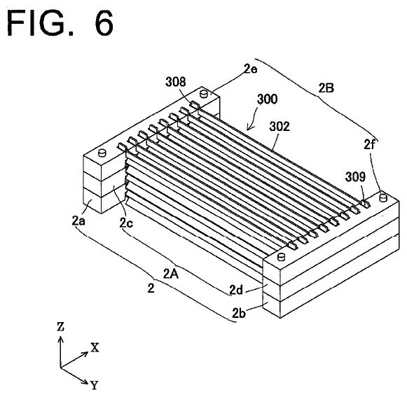

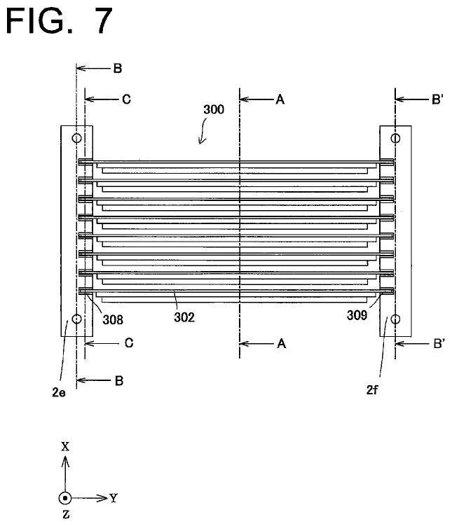

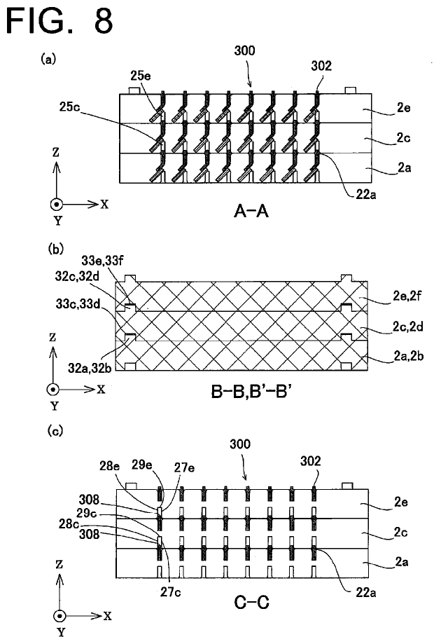

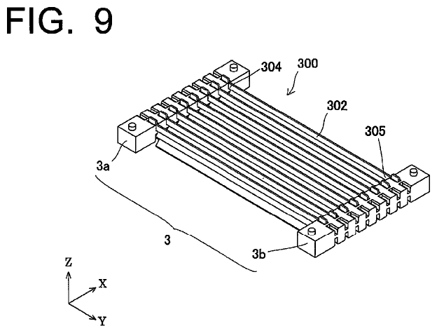

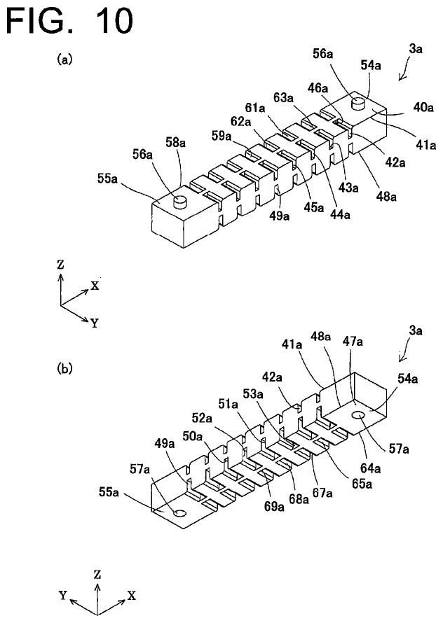

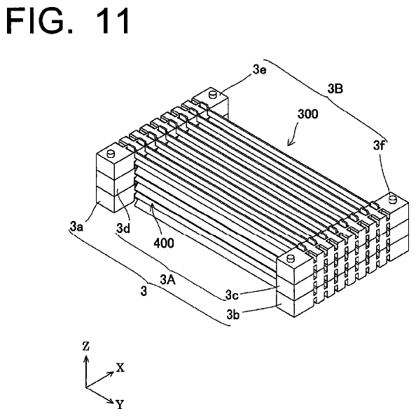

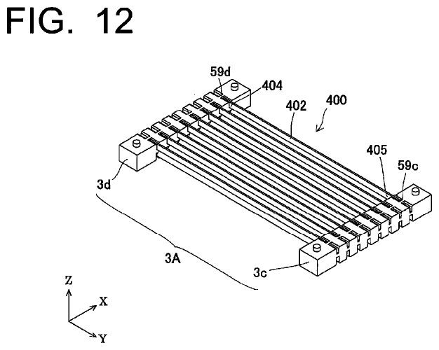

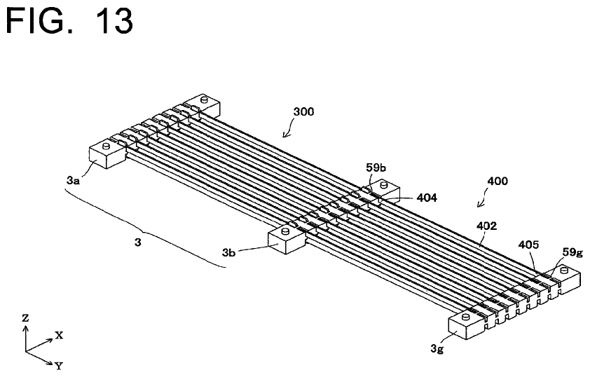

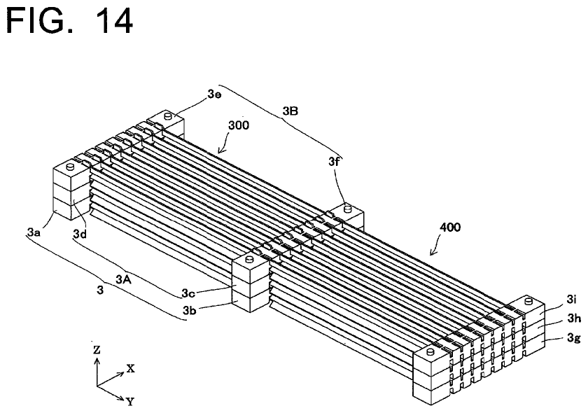

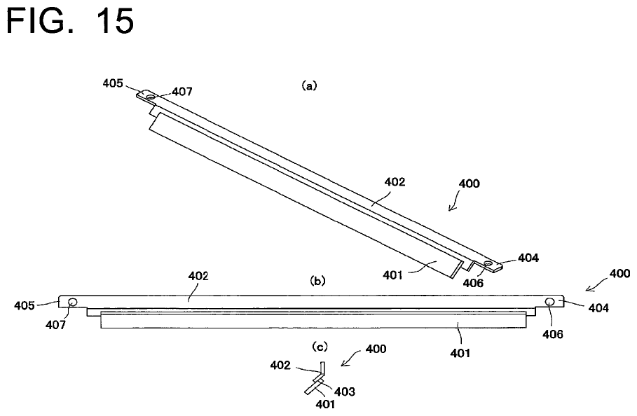

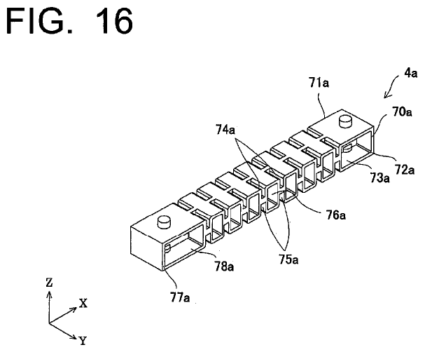

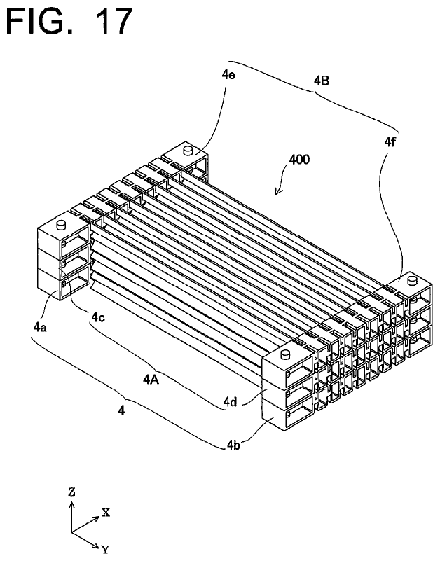

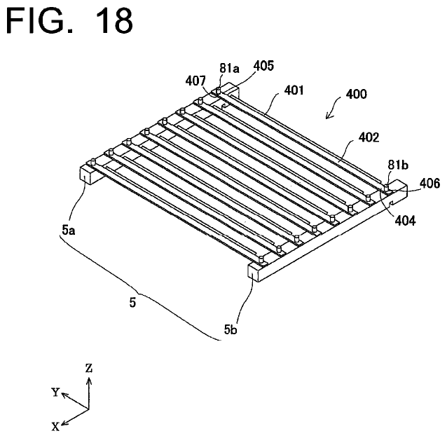

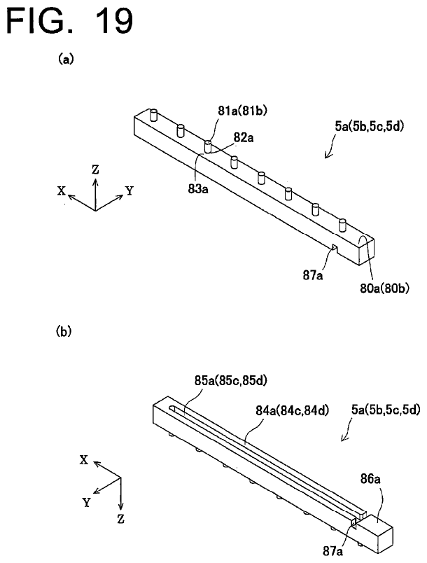

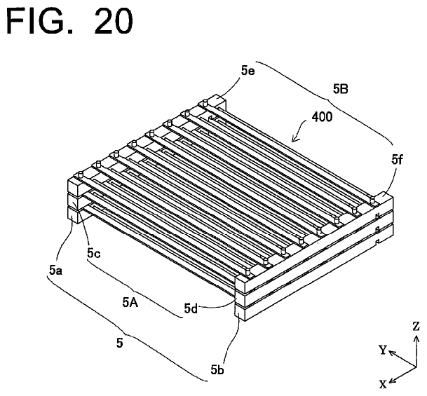

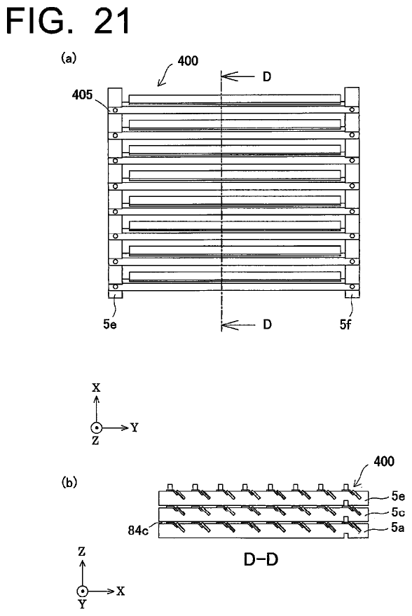

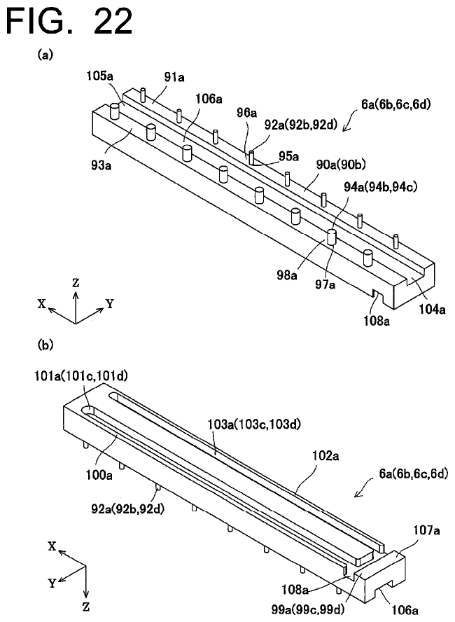

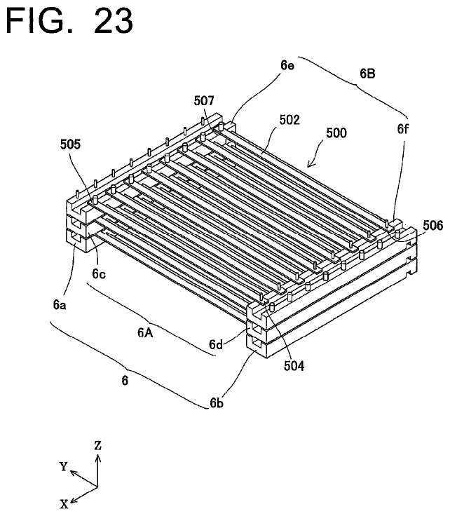

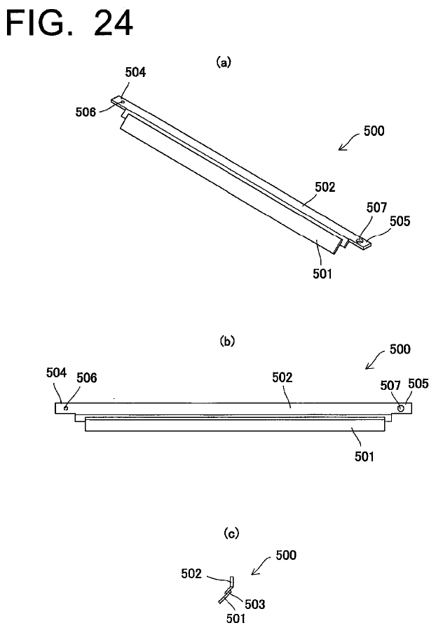

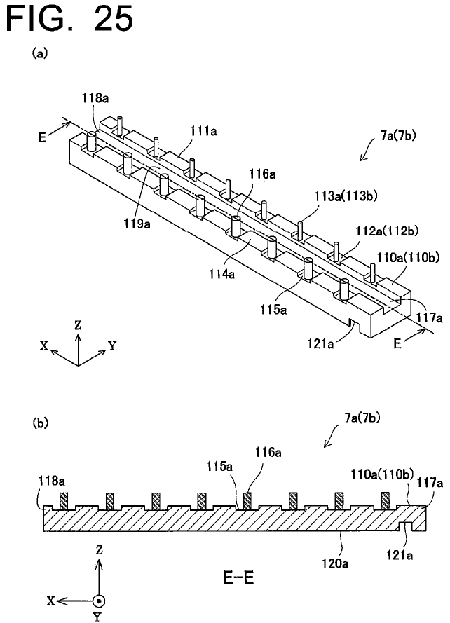

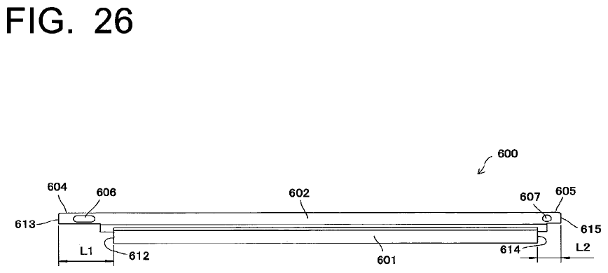

### BRIEF DESCRIPTION OF THE DRAWINGS

[FIG. 1] Perspective view showing an example of a mode of use of a packaging member for cleaning blades according to embodiment 1.

[FIG. 2] Perspective view showing an example of one packaging member main body of the packaging member for cleaning blades according to embodiment 1.

[FIG. 3] (a) is a perspective view showing an example of a cleaning blade applicable to the present invention, and (b) is a side view of (a).

[FIG. 4] Perspective view showing an example of a mode of use of a packaging member for cleaning blades according to embodiment 2.

[FIG. 5] (a) is a perspective view showing an example of one packaging member main body of the packaging member for cleaning blades according to embodiment 2, and (b) is a bottom view of (a).

[FIG. 6] Perspective view showing an example of a mode of use of the packaging member for cleaning blades according to embodiment 2.

[FIG. 7] Plan view of FIG. 6.

[FIG. 8] (a) is a sectional view taken along line A-A of FIG. 7, (b) is a sectional view taken along line B-B and line B′-B′ of FIG. 7, and (c) is a sectional view taken along line C-C of FIG. 7.

[FIG. 9] Perspective view showing an example of a mode of use of a packaging member for cleaning blades according to embodiment 3.

[FIG. 10] (a) is a perspective view showing an example of one packaging member main body of the packaging member for cleaning blades according to embodiment 3, and (b) is a bottom view of (a).

[FIG. 11] Perspective view showing an example of a mode of use of the packaging member for cleaning blades according to embodiment 3.

[FIG. 12] Perspective view showing an example of a mode of use of the packaging member for cleaning blades according to embodiment 3.

[FIG. 13] Perspective view showing an example of a mode of use of the packaging member for cleaning blades according to embodiment 3.

[FIG. 14] Perspective view showing an example of a mode of use of the packaging member for cleaning blades according to embodiment 3.

[FIG. 15] (a) is a perspective view showing an example of a cleaning blade applicable to the present invention, (b) is a plan view of (a), and (c) is a side view of (a).

[FIG. 16] Perspective view showing an example of one packaging member main body of a packaging member for cleaning blades according to embodiment 4.

[FIG. 17] Perspective view showing an example of a mode of use of the packaging member for cleaning blades according to embodiment 4.

[FIG. 18] Perspective view showing an example of a mode of use of a packaging member for cleaning blades according to embodiment 5.

[FIG. 19] (a) is a perspective view showing an example of one packaging member main body of the packaging member for cleaning blades according to embodiment 5, and (b) is a bottom view of (a).

[FIG. 20] Perspective view showing an example of a mode of use of the packaging member for cleaning blades according to embodiment 5.

[FIG. 21] (a) is a plan view of FIG. 20, and (b) is a sectional view taken along line D-D of (a).

[FIG. 22] (a) is a perspective view showing an example of one packaging member main body of a packaging member for cleaning blades according to embodiment 6, and (b) is a bottom view of (a).

[FIG. 23] Perspective view showing an example of a mode of use of a packaging member for cleaning blades according to embodiment 6.

[FIG. 24] (a) is a perspective view showing an example of a cleaning blade applicable to the present invention, (b) is a plan view of (a), and (c) is a side view of (a).

[FIG. 25] (a) is a perspective view showing an example of one packaging member main body of a packaging member for cleaning blades according to embodiment 7, and (b) is a sectional view taken along line E-E of (a).

[FIG. 26] Plan view showing an example of a cleaning blade applicable to the present invention.

### MODES FOR CARRYING OUT THE INVENTION

The present invention will next be described in detail with reference to embodiments. The following description discusses modes for carrying out the present invention, and the present invention can be modified arbitrarily without departing from the gist of the invention. Since constituent elements denoted by the same reference numeral in the drawings are the same, repeated description thereof is omitted as appropriate. Letters (a to i, A, and B) appearing in reference numerals are suffixed for convenience of description of a plurality of the same constituent elements, and reference numerals bearing the same numeral denote the same constituent elements unless otherwise specified.

In the drawings, X, Y, and Z indicate three mutually orthogonal spatial axes. In the present specification, directions along the X-, Y-, and Z-axes are referred to as a first direction X (X-direction), a second direction Y (Y-direction), and a third direction Z (Z-direction), respectively. The X-direction and the Y-direction indicate in-plane directions of constituent elements, and the Z-direction indicates a height direction, a thickness direction, or a stacking direction of the constituent elements.

### Embodiment 1

### [1. Packaging Member for Cleaning Blades]

First, a packaging member for cleaning blades (hereinafter, called the “packaging member”) according to a first embodiment (hereinafter, called “embodiment 1”) of the present invention will be described. As shown in FIG. 1, a packaging member 1 consists of a set of packaging member main bodies supporting respective longitudinal (Y-direction) opposite end portions 304 and 305 of holder parts 302 of cleaning blades 300 (see FIG. 3), which will be described later herein, each having a blade main body 301 and the holder part 302. The packaging member main bodies consist of one first packaging member main body 1a and the other first packaging member main body 1b. Through employment of such a configuration, the packaging member 1 can package the cleaning blades 300 while supporting the opposite end portions 304 and 305 of the cleaning blades 300 by the first packaging member main body 1a and the first packaging member main body 1b.

In embodiment 1, the one first packaging member main body 1a and the other first packaging member main body 1b are the same members (hereinafter, called “common members”). Therefore, the structure of the first packaging member main body 1a is mainly described herein, and description of the first packaging member main body 1b is omitted as appropriate.

The first packaging member main body 1a and the first packaging member main body 1b which constitute the packaging member 1 are approximately rectangular parallelepiped members formed of hard resin. Thus, the packaging member 1 exhibits excellent load bearing performance and can prevent its deformation, breakage, etc., associated with handling thereof. As a result, the packaging member 1 can be collected and reused, thereby realizing a great reduction in the costs of packaging work, transportation, etc., of the cleaning blades 300. Also, since the packaging member 1 can be reused, the amount of disposal of packaging member 1 wastes can be reduced, whereby an increase in environmental load resulting from disposal of packaging member 1 wastes can be minimized, and the cost of disposal can be greatly reduced. Further, in the packaging member 1, since the first packaging member main body 1a and the first packaging member main body 1b are common members, the amount of material; specifically, hard resin, used in manufacturing the packaging member 1 can be reduced, whereby the cost of manufacturing the packaging member 1 can be greatly reduced.

Next, the first packaging member main body 1a which partially constitutes the packaging member 1 will be described. As shown in FIG. 2, the first packaging member main body 1a has eight support parts 12a formed in a recessed manner in one edge portion 11a (in a lateral direction (Y-direction)) of an upper surface 10a of the first packaging member main body 1a at fixed intervals along a longitudinal direction (X-direction). The support parts 12a are formed at equal intervals and have the same shape; specifically, the same rectangular cross section. That is, the first packaging member main body 1a has a plurality of grooves (support parts 12a) having the same shape and formed in the edge portion 11a at equal intervals.

The support part 12a has a lower surface 13a for bearing a lower edge portion 310 (see FIG. 3) of the holder part 302 of the cleaning blade 300 stored in the packaging member 1, opposite side walls 14a and 15a which come into contact with corresponding opposite side surfaces 316 and 317 (see FIG. 3) of the end portion 304 of the holder part 302, and a recess wall 16a which comes into contact with a longitudinal end 312 (see FIG. 3) of the cleaning blade 300.

In embodiment 1, when the end portion 304 of the holder part 302 is inserted into the support part 12a of the one first packaging member main body 1a, the lower surface 13a of the support part 12a bears the lower edge portion 310 of the holder part 302, whereby the end portion 304 is received in the support part 12a. At this time, the end portion 304 of the holder part 302 is supported at three points; specifically, by the opposite side walls 14a and 15a and the recess wall 16a of the support part 12a, whereby the end portion 304 is positioned in a predetermined posture and held in that condition. Similarly, when the end portion 305 of the holder part 302 is received in the support part 12b (see FIG. 1) of the other first packaging member main body 1b to thereby be positioned, the cleaning blade 300 is held in the space between a set of packaging member main bodies (the first packaging member main body 1a and the first packaging member main body 1b).

Since the cleaning blade 300 is restricted in movements at least in a downward direction (Z-direction), a longitudinal direction (Y-direction), and a lateral direction (X-direction) by the lower surface 13a, the opposite side walls 14a and 15a, and the recess wall 16a, respectively, of the support part 12a, even when the cleaning blades 300 move due to transportation or the like, the cleaning blades 300 do not drop off the packaging member 1. As a result, the packaging member 1 can prevent the occurrence of deformation, breakage, etc., of the cleaning blade 300 which could otherwise result from dropping of the cleaning blade 300.

As shown in FIG. 1, since the packaging member 1 consisting of the first packaging member main body 1a and the first packaging member main body 1b has the eight support parts 12a and the eight support parts 12b, the packaging member 1 can package a total of eight cleaning blades 300 at a time, whereby the packaging member 1 can increase storage rate and work efficiency. As a result, the packaging member 1 can reduce personnel, time, etc., involved in work and can greatly reduce the costs of packaging work, transportation, etc.

Also, in the packaging member 1, the one first packaging member main body 1a and the other first packaging member main body 1b are common members. Therefore, the packaging member 1 can be used to pack different cleaning blades whose longitudinal lengths differ from that of the cleaning blades 300 without being designed for dedicated use for the different pack cleaning blades, if the opposite end portions of the holder parts of the different cleaning blades have the same shape. Therefore, embodiment 1 can provide a packaging member having such high versatility as to be applicable to packaging of all cleaning blades whose opposite end portions of holder parts have a common shape. Also, since the first packaging member main body 1a and the first packaging member main body 1b are made common, the manufacturing process can be simplified, whereby the cost of manufacturing the packaging member 1 can be greatly reduced.

### [2. Mode of Use of Packaging Member for Cleaning Blades]

Next, a mode of use of the packaging member 1 will be described. As shown in FIG. 1, first, the first packaging member main body 1a, the first packaging member main body 1b, and eight cleaning blades 300 are prepared. Next, the end portion 304 of the holder part 302 of the first cleaning blade 300 is inserted into the support part 12a of the first packaging member main body 1a. Similarly, the end portion 305 of the holder part 302 is inserted into the support part 12b of the first packaging member main body 1b, whereby the opposite end portions 304 and 305 are supported by the support parts 12a and 12b, respectively. By this procedure, the first cleaning blade 300 is stored in the space between the first packaging member main body 1a and the first packaging member main body 1b.

Next, similar to the case of the first cleaning blade 300, the second to eighth cleaning blades 300 are supported at the opposite end portions 304 and 305 by the support parts 12a and 12b. By this procedure, the second through eighth cleaning blades 300 are all stored in the space between the first packaging member main body 1a and the first packaging member main body 1b, thereby completing packaging of the cleaning blades 300 in the packaging member 1.

### [3. Cleaning Blade]

Next, a cleaning blade applicable to the packaging member 1 will be described. The present cleaning blade can also be applied to other embodiments to be described later herein.

As shown in FIG. 3, the cleaning blade 300 includes the blade main body 301 (also called a “cleaning blade”) which comes into slide contact with the surface of a latent image carrier (not shown) such as a photosensitive drum, and the holder part 302 which supports a non-slide-contact portion of the blade main body 301. More specifically, the cleaning blade 300 includes the blade main body 301 and the holder part 302 bonded through an adhesive (not shown) to one lateral end portion 303 of the blade main body 301.

The blade main body 301 is formed of a rectangular plate, and the material of the plate is not particularly limited, but can be selected as appropriate so long as the blade main body 301 can clean off remaining toner from the surface of the latent image carrier without damaging the surface of the latent image carrier. For example, the blade main body 301 can be an elastic member formed of a rubber-based material. The shape of the blade main body 301 is not limited to a rectangular shape, but can be modified as appropriate according to an image forming apparatus (an electrophotographic copier and printer, a toner-jet copier and printer, or the like) to which the cleaning blade 300 is applied.

A material of the holder part 302 can be appropriately selected as needed so long as the material has an appropriate strength for supporting the blade main body 301. For example, the holder part 302 may be formed of metal such as SUS. The shape of the holder part 302 is not limited to the illustrated shape, but can be modified as appropriate according to an image forming apparatus to which the cleaning blade 300 is applied, so long as the holder part 302 can support the blade main body 301.

The holder part 302 has holes 306 and 307 having an approximately circular shape in plan view and extending in a thickness direction through the respective longitudinal opposite end portions 304 and 305. The holes 306 and 307 differ in diameter such that the diameter of the hole 307 is smaller than the diameter of the hole 306. No particular limitation is imposed on the diameter, shape, etc., of the holes 306 and 307; the holes 306 and 307 may be identical or differ in diameter, shape, etc.; and the diameter, shape, etc., can be appropriately changed as needed.

Further, the holder part 302 has rectangular protrusions 308 and 309 protruding from the respective longitudinal opposite end portions 304 and 305 in a lateral direction of the holder part 302 opposite the blade main body 301. The shape, etc., of the protrusions 308 and 309 are not particularly limited, but can be modified as appropriate according to an image forming apparatus to which the cleaning blade is applied.

### Embodiment 2

First, a packaging member according to a second embodiment (hereinafter, called “embodiment 2”) of the present invention will be described. As shown in FIG. 4, a packaging member 2 consists of a set of packaging member main bodies supporting respective opposite end portions 304 and 305 of the holder parts 302 of the cleaning blades 300. The packaging member main bodies consist of one first packaging member main body 2a and the other first packaging member main body 2b. Through employment of such a configuration, the packaging member 2 can package the cleaning blades 300. The one first packaging member main body 2a and the other first packaging member main body 2b are common members.

Since the packaging member 2 is a modified embodiment of the packaging member 1 and is configured similarly to the packaging member 1 except for having a vertically (Z-direction) stackable structure, the packaging member 2 can yield all of excellent effects of the packaging member 1. Description of embodiment 2 covers only configurational features of the packaging member 2 different from those of the packaging member 1, and repeated description of other configurational features is omitted.

Next, the first packaging member main body 2a which partially constitutes the packaging member 2 will be described. As shown in FIG. 5, the first packaging member main body 2a has eight support parts 22a formed in a recessed manner in one edge portion 21a (in the lateral direction (Y-direction)) of an upper surface 20a of the first packaging member main body 2a, similarly to the case of the first packaging member main body la; further, the first packaging member main body 2a has eight recesses 25a formed in one edge portion 24a (in the lateral direction) of a lower surface 23a of the first packaging member main body 2a at fixed intervals along the longitudinal direction (X-direction). The recesses 25a are formed at equal intervals corresponding to the support parts 22a, and each of the recesses 25a has the same shape as that of the support part 22a; i.e., the same rectangular cross section. That is, the first packaging member main body 2a has a plurality of grooves (support parts 22a and recesses 25a) having the same shape and formed in the edge portion 21a and in the edge portion 24a at equal intervals.

The recess 25a has an upper surface 26a which comes into contact with an upper edge portion 311 (see FIG. 3) of the protrusion 308 of the holder part 302 of the cleaning blade 300 stored in another packaging member underlying the packaging member 2, opposite side walls 27a and 28a which come in contact with corresponding opposite side surfaces 318 and 319 (see FIG. 3) of the protrusion 308, and a recess wall 29a adapted to restrict movement of a longitudinal end 314 (see FIG. 3) of the protrusion 308.

The first packaging member main body 2a has a vertically (Z-direction) stackable structure. Specifically, the first packaging member main body 2a has approximately cylindrical engagement protrusions 32a protruding from the upper surface 20a at respective longitudinal (X-direction) opposite end portions 30a and 31a and has engagement recesses 33a formed in the lower surface 23a at the respective longitudinal opposite end portions 30a and 31a, having an approximately circular shape in plan view, and being able to be engaged with the corresponding engagement protrusions 32a. Through employment of such a structure, the first packaging member main bodies 2a can be vertically stacked.

As shown in FIG. 6, stacking of the packaging members 2 uses a packaging member 2A consisting of another set of packaging member main bodies (a second packaging member main body 2c and a second packaging member main body 2d), and a packaging member 2B consisting of another set of packaging member main bodies (a third packaging member main body 2e and a third packaging member main body 2f). In embodiment 2, the first packaging member main body 2a, the second packaging member main body 2c, and the third packaging member main body 2e are common members, and the first packaging member main body 2b, the second packaging member main body 2d, and the third packaging member main body 2f are common members.

In embodiment 2, similar to the case of embodiment 1, eight cleaning blades 300 are held in the space between the first packaging member main body 2a and the first packaging member main body 2b (see FIG. 4), thereby completing packaging of the cleaning blades 300 in the packaging member 2 at the first level. Subsequently, as shown in FIGS. 7 and 8, the second packaging member main body 2c is stacked on the first packaging member main body 2a while the engagement protrusions 32a of the first packaging member main body 2a and the engagement recesses 33c of the second packaging member main body 2c are engaged together. Similarly, the second packaging member main body 2d is stacked on the first packaging member main body 2b while the engagement protrusions 32b of the first packaging member main body 2b and the engagement recesses 33d of the second packaging member main body 2d are engaged together; then, eight cleaning blades 300 are held in the space between the second packaging member main body 2c and the second packaging member main body 2d, thereby completing packaging of the cleaning blades 300 in the packaging member 2A at the second level (see FIG. 6).

At this time, as shown in FIG. 8, each of the protrusions 308 of the holder parts 302 is supported at three points; specifically, by opposite side walls 27c and 28c and recess wall 29c of a recess 25c of the second packaging member main body 2c; similarly, the protrusions 309 of the holder parts 302 are held by the second packaging member main body 2d.

Similarly, the third packaging member main body 2e is stacked on the second packaging member main body 2c while the engagement protrusions 32c of the second packaging member main body 2c and the engagement recesses 33e of the third packaging member main body 2e are engaged together; the third packaging member main body 2f is stacked on the second packaging member main body 2d while the engagement protrusions 32d of the second packaging member main body 2d and the engagement recesses 33f of the third packaging member main body 2f are engaged together; and eight cleaning blades 300 are held in the space between the third packaging member main body 2e and the third packaging member main body 2f, thereby completing packaging of the cleaning blades 300 in the packaging member 2B at the third level (see FIG. 6).

At this time, each of the protrusions 308 of the holder parts 302 is supported at three points; specifically, by opposite side walls 27e and 28e and recess wall 29e of a recess 25e of the third packaging member main body 2e; similarly, the protrusions 309 of the holder parts 302 are held by the third packaging member main body 2f.

That is, in embodiment 2, since one packaging member main body and the other packaging member main body of a set of packaging member main bodies have a vertically (Z-direction) stackable structure; i.e., have engagement protrusions and engagement recesses, as shown in FIG. 6, the packaging member 2, the packaging member 2A, and the packaging member 2B can be stacked together. According to embodiment 2, by virtue of such a structure, storage rate of the cleaning blades 300 and work efficiency can be greatly increased; as a result, personnel, time, etc., involved in work can be reduced, and the costs of packaging work, transportation, etc., can be greatly reduced.

Also, according to embodiment 2, as a result of the first packaging member main body 2a having a vertically (Z-direction) stackable structure, in addition to movements of the cleaning blade 300 in the downward direction (Z-direction), the longitudinal direction (Y-direction), and the lateral direction (X-direction), movement of the cleaning blade 300 in an upward direction (Z-direction) can be restricted. That is, as shown in FIG. 8, since the posture of the cleaning blade 300 positioned by the support part 22a of the first packaging member main body 2a is held further firmly by the recess 25c of the overlying second packaging member main body 2c, even when the cleaning blades 300 move due to transportation or the like, the cleaning blades 300 do not come into contact with other cleaning blades 300, thereby avoiding mutual interference of the cleaning blades 300. As a result, according to embodiment 2, even though the packaging member 2, the packaging member 2A, and the packaging member 2B are stacked together, the occurrence of deformation, breakage, etc., of the cleaning blades 300 can be prevented.

### Embodiment 3

### [1. Packaging Member for Cleaning Blades]

First, a packaging member according to a third embodiment (hereinafter, called “embodiment 3”) of the present invention will be described. As shown in FIG. 9, a packaging member 3 consists of a set of packaging member main bodies supporting the respective opposite end portions 304 and 305 of the holder parts 302 of the cleaning blades 300. The packaging member main bodies consist of one first packaging member main body 3a and the other first packaging member main body 3b. Through employment of such a configuration, the packaging member 3 can package the cleaning blades 300. The one first packaging member main body 3a and the other first packaging member main body 3b are common members.

Since the packaging member 3 is a modified embodiment of the packaging member 2 and is configured similarly to the packaging member 2 except for having a structure which allows simultaneous packaging of the cleaning blades 300 and cleaning blades 400 (see FIG. 15) different in shape from the cleaning blades 300, the packaging member 3 can yield all of excellent effects of the packaging member 2. Description of embodiment 3 covers only configurational features of the packaging member 3 different from those of the packaging member 2, and repeated description of other configurational features is omitted. The cleaning blade 400 will be described later herein.

The first packaging member main body 3a which partially constitutes the packaging member 3 will be described. As shown in FIG. 10, the first packaging member main body 3a has eight support parts 42a formed in a recessed manner in one edge portion 41a (in the lateral direction (Y-direction)) of an upper surface 40a of the first packaging member main body 3a, similarly to the case of the first packaging member main body 2a. The support part 42a has a lower surface 43a, opposite side walls 44a and 45a, and a recess wall 46a.

Also, similar to the case of the first packaging member main body 2a, the first packaging member main body 3a has eight recesses 49a formed in one edge portion 48a (in the lateral direction) of a lower surface 47a of the first packaging member main body 3a. The recess 49a has an upper surface 50a, opposite side walls 51a and 52a, and a recess wall 53a.

Further, similar to the case of the first packaging member main body 2a, the first packaging member main body 3a has approximately cylindrical engagement protrusions 56a protruding from the upper surface 40a at respective longitudinal (X-direction) opposite end portions 54a and 55a and has engagement recesses 57a formed in the lower surface 47a at the respective longitudinal opposite end portions 54a and 55a, having an approximately circular shape in plan view, and being able to be engaged with the corresponding engagement protrusions 56a.

Also, the first packaging member main body 3a has eight support parts 59a formed in a recessed manner in the other edge portion 58a (in the lateral direction (Y-direction)) of the upper surface 40a of the first packaging member main body 3a at equal intervals corresponding to the support parts 42a along the longitudinal direction (X-direction). Similar to the case of the support part 42a, the support part 59a has a lower surface (not shown), opposite side walls 61a and 62a, and a recess wall 63a. The first packaging member main body 3a also has eight recesses 65a formed in the other edge portion 64a (in the lateral direction) of the lower surface 47a of the first packaging member main body 3a at equal intervals corresponding to the recesses 49a along the longitudinal direction. Similar to the case of the recess 49a, the recess 65a has an upper surface (not shown), opposite side walls 67a and 68a, and a recess wall 69a.

As mentioned above, the eight support parts 42a and the eight support parts 59a are formed in the upper surface 40a of the first packaging member main body 3a in a recessed manner at equal intervals in an aligned manner along the longitudinal direction (X-direction); however, the support part 42a and the support part 59a differ in width along the longitudinal direction such that the support part 59a is greater in width. Also, the eight recesses 49a and the eight recesses 65a are formed in the lower surface 47a at equal intervals in an aligned manner along the longitudinal direction; however, the recess 49a and the recess 65a differ in width along the longitudinal direction such that the recess 65a is greater in width.

In embodiment 3, similar to the case of embodiment 2, the cleaning blades 300 can be held in the space between the one first packaging member main body 3a and the other first packaging member main body 3b (see FIG. 9). Since the held cleaning blades 300 are restricted in movements at least in the downward direction (Z-direction), the longitudinal direction (Y-direction), and the lateral direction (X-direction) of the cleaning blades 300, even when the cleaning blades 300 move due to transportation or the like, the cleaning blades 300 do not drop off the packaging member 3. Also, a total of eight cleaning blades 300 can be packaged at a time, so that storage rate and work efficiency can be increased; therefore, personnel, time, etc., involved in work can be reduced, whereby the costs of packaging work, transportation, etc., can be greatly reduced.

As shown in FIG. 11, the first packaging member main body 3a has a vertically (Z-direction) stackable structure. By stacking the packaging members 3, a packaging member 3A consisting of one second packaging member main body 3c and the other second packaging member main body 3d, and a packaging member 3B consisting of one third packaging member main body 3e and the other third packaging member main body 3f, a total of 24 cleaning blades 300 can be packaged at a time, whereby storage rate and work efficiency can be further increased.

According to embodiment 3, since the support parts 42a and the support parts 59a differ in shape, the cleaning blades 300 and the cleaning blades 400 (see FIG. 15) different from the cleaning blades 300 in thickness of the holder part can be packaged at a time. More specifically, the cleaning blades of two types are packaged such that the packaging member 3 storing the cleaning blades 300, the packaging member 3A storing the cleaning blades 400, and the packaging member 3B storing the cleaning blades 300 are sequentially stacked.

As shown in FIG. 12, in the case of packaging the cleaning blades 400 by use of the packaging member 3A, opposite end portions 404 and 405 of holder parts 402 of the cleaning blades 400 are supported by support parts 59d and 59c compatible with the cleaning blades 400. Thus, the cleaning blades 400 can be stored while being held between the second packaging member main body 3d and the second packaging member main body 3c.

According to embodiment 3, one packaging member main body has the support parts of two types to thereby enable common use of the packaging member main bodies, whereby the versatility of the packaging member can be further improved. That is, through common use of the packaging member main bodies, a plurality of types of cleaning blades compatible with the shapes of the support parts can be packaged, whereby storage rate and work efficiency can be further increased. Since different cleaning blades can be packaged at a time, particularly, the cost of transportation can be greatly reduced.

### [2. Mode of Use of Packaging Member for Cleaning Blades]

Next, a mode of use of the packaging member 3 will be described. As shown in FIG. 9, first, the first packaging member main body 3a, the first packaging member main body 3b, and eight cleaning blades 300 are prepared. Next, similar to the case of the packaging member 2, the first to eighth cleaning blades 300 are stored in the space between the first packaging member main body 3a and the first packaging member main body 3b.

As a result, all of the cleaning blades 300 are stored in the space between the first packaging member main body 3a and the first packaging member main body 3b, thereby completing packaging of the cleaning blades 300 in the first-level packaging member 3.

Next, as shown in FIG. 11, the second packaging member main body 3c, the second packaging member main body 3d, and eight cleaning blades 400 are prepared. First, the second packaging member main body 3d is stacked on the first packaging member main body 3a; the second packaging member main body 3c is stacked on the first packaging member main body 3b; and the first to eighth cleaning blades 400 are stored in the space between the second packaging member main body 3d and the second packaging member main body 3c. At this time, the cleaning blades 400 are supported by the support parts 59d and 59c (see FIG. 12) compatible with the cleaning blades 400. As a result, packaging of the cleaning blades 400 in the second-level packaging member 3A is completed.

Next, the third packaging member main body 3e, the third packaging member main body 3f, and eight cleaning blades 300 are prepared. First, similar to the case of embodiment 2, the packaging member 3B is stacked on the packaging member 3A, and all of the first to eighth cleaning blades 300 are stored in the space between the third packaging member main body 3e and the third packaging member main body 3f. As a result, packaging of the cleaning blades 300 in the third-level packaging member 3B is completed, whereby packaging of the cleaning blades 300 and the cleaning blades 400 at all levels in embodiment 3 is completed.

According to embodiment 3, by another method, the cleaning blades 300 and the cleaning blades 400 can be packaged at a time. Specifically, as shown in FIG. 13, by use of the packaging member 3 in which the cleaning blades 300 are stored, and a first packaging member main body 3g which is a common member of the first packaging member main body 3a, eight cleaning blades 400 are stored, similarly to the case of the packaging member 3. At this time, the longitudinal opposite end portions 404 and 405 of the holder parts 402 of the cleaning blades 400 are supported by support parts 59b of the first packaging member main body 3b and support parts 59g of the first packaging member main body 3g, respectively. The packaging member 3 and the first packaging member main body 3g in which the cleaning blades 300 and the cleaning blades 400 are respectively stored are on the same plane (on an X-Y plane).

Similarly, as shown in FIG. 14, by use of the packaging member 3A having the cleaning blades 300 stored therein and stacked on the packaging member 3, and a second packaging member main body 3h which is a common member of the second packaging member main body 3c, eight cleaning blades 400 are stored, similarly to the case of the packaging member 3 and the first packaging member main body 3g. Further, by use of the packaging member 3B having the cleaning blades 300 stored therein and stacked on the packaging member 3A, and a third packaging member main body 3i which is a common member of the third packaging member main body 3e, eight cleaning blades 400 are stored, similarly to the case of the packaging member 3 and the first packaging member main body 3g. According to embodiment 3, this packaging method can also package a total of 24 cleaning blades 300 and a total of 24 cleaning blades 400 at a time.

As mentioned above, embodiment 3 not only allows stacking, in the vertical direction (Z-direction), of a packaging member having cleaning blades of one type stored therein and a packaging member having cleaning blades of another type, but also allows packaging members having cleaning blades of different shapes stored therein to be disposed on the same plane (X-Y plane), whereby cleaning blades of a plurality of types can be packaged. That is, embodiment 3 allows selection of an optimum packaging method as appropriate in accordance with a case in which the packaging members are to be contained.

### [3. Cleaning Blade]

Next, a cleaning blade applicable to the packaging member 3 will be described. The present cleaning blade can also be applied to other embodiments.

As shown in FIG. 15, similar to the cleaning blade 300, the cleaning blade 400 includes a blade main body 401 and a holder part 402. The holder part 402 is bonded through an adhesive (not shown) to one lateral end portion 403 of the blade main body 401. The holder part 402 has holes 406 and 407 having an approximately circular shape in plan view and extending in a thickness direction through the respective longitudinal opposite end portions 404 and 405. The holes 406 and 407 have the same diameter and the same shape. The cleaning blade 400 does not have the protrusions formed on the cleaning blade 300.

### Embodiment 4

[1. Packaging Member for cleaning Blades]

First, a packaging member according to a fourth embodiment (hereinafter, called “embodiment 4”) of the present invention will be described. Since a packaging member 4 (see FIG. 17) is a modified embodiment of the packaging member 3 and is configured similarly to the packaging member 3 except for having a weight-reduced structure, the packaging member 4 can yield all of excellent effects of the packaging member 3. Description of embodiment 4 covers only configurational features of the packaging member 4 different from those of the packaging member 3, and repeated description of other configurational features is omitted. In embodiment 4, the cleaning blade 400 (see FIG. 15) is applied.

Next, a first packaging member main body 4a which partially constitutes the packaging member 4 will be described. As shown in FIG. 16, each of opposite side surfaces 70a and 71a of the first packaging member main body 4a has a side recess 73a formed in an end portion 72a located at one end in the longitudinal direction (X-direction), side recesses 76a formed in respective regions each surrounded by two support parts 74a and two recesses 75a, and a side recess 78a formed in an end portion 77a located at the other end in the longitudinal direction.

According to embodiment 4, the first packaging member main body 4a has the side recesses 73a, 76a, and 78a formed in the opposite side surfaces 70a and 71a at predetermined positions, whereby the weight of the first packaging member main body 4a can be reduced. As a result of the first packaging member main body 4a being reduced in weight, material cost can be reduced; accordingly, the cost of manufacturing the packaging member 4 can be reduced. Notably, the one first packaging member main body 4a and the other first packaging member main body 4b are common members.

### [2. Mode of Use of Packaging Member for Cleaning Blades]

Next, a mode of use of the packaging member 4 will be described. As shown in FIG. 17, in the packaging member 4, similar to the case of the packaging member 3, all of eight cleaning blades 400 are stored in the space between the first packaging member main body 4a and the first packaging member main body 4b, thereby completing packaging of the cleaning blades 400 in the first-level packaging member 4.

Similarly, by use of a packaging member 4A consisting of another set of packaging member main bodies (a second packaging member main body 4c and a second packaging member main body 4d), all of eight cleaning blades 400 are stored in the space between the second packaging member main body 4c and the second packaging member main body 4d, thereby completing packaging of the cleaning blades 400 in the second-level packaging member 4A.

Further, by use of a packaging member 4B consisting of another set of packaging member main bodies (a third packaging member main body 4e and a third packaging member main body 4f), all of eight cleaning blades 400 are stored in the space between the third packaging member main body 4e and the third packaging member main body 4f, thereby completing packaging of the cleaning blades 400 in the third-level packaging member 4B.

By sequentially stacking the packaging member 4, the packaging member 4A, and the packaging member 4B as mentioned above, embodiment 4 can yield effects similar to those of embodiment 3 in which the packaging member 3, the packaging member 3A, and the packaging member 3B are stacked together.

### Embodiment 5

### [1. Packaging Member for Cleaning Blades]

First, a packaging member according to a fifth embodiment (hereinafter, called “embodiment 5”) of the present invention will be described. As shown in FIG. 18, a packaging member 5 consists of a set of packaging member main bodies for supporting respective longitudinal (Y-direction) opposite end portions 405 and 404 of the holder parts 402 of the cleaning blades 400 each having the blade main body 401 and the holder part 402. The packaging member main bodies consist of one first packaging member main body 5a and the other first packaging member main body 5b. Through employment of such a configuration, the packaging member 5 can package the cleaning blades 400 while supporting the opposite end portions 405 and 404 of the cleaning blades 400 by the first packaging member main body 5a and the first packaging member main body 5b.

In embodiment 5, the one first packaging member main body 5a and the other first packaging member main body 5b are the same members (hereinafter, called “common members”). Therefore, the structure of the first packaging member main body 5a is mainly described herein, and description of the first packaging member main body 5b is omitted as appropriate.

Since the packaging member 5 is a modified embodiment of the packaging member 2 and is configured similarly to the packaging member 2 except for a structure of supporting opposite ends of the cleaning blade and a structure of vertically stacking the packaging members, the packaging member 5 can yield all of excellent effects of the packaging member 2. Description of embodiment 5 covers only configurational features of the packaging member 5 different from those of the packaging member 2, and repeated description of other configurational features is omitted.

Next, the first packaging member main body 5a which partially constitutes the packaging member 5 will be described. As shown in FIG. 19, the first packaging member main body 5a has eight insertion protrusions 81a protruding from an upper surface 80a of the first packaging member main body 5a and disposed at fixed intervals along the longitudinal direction (X-direction). The insertion protrusion 81a has an approximately circular columnar shape and allows the hole 407 provided in the end portion 405 of the holder part 402 to be fitted thereto (see FIG. 18).

In the first packaging member main body 5a, when the end portion 405 of the holder part 402 is placed on the upper surface 80a while the hole 407 of the holder part 402 is fitted to the insertion protrusion 81a, the periphery of a lower end portion 82a of the insertion protrusion 81a serves as a rest portion 83a for supporting the end portion 405.

According to embodiment 5, when the hole 407 of the end portion 405 of the holder part 402 is fitted to the insertion protrusion 81a of the first packaging member main body 5a, the rest portion 83a comes into contact with and supports the end portion 405. At this time, the end portion 405 of the holder part 402 is positioned in a predetermined posture and held in the positioned condition by the insertion protrusion 81a. Similarly, when the hole 406 of the end portion 404 is fitted to an insertion protrusion 81b of the first packaging member main body 5b to thereby be positioned, the cleaning blade 400 is held in the space between the first packaging member main body 5a and the first packaging member main body 5b.

Since the cleaning blade 400 is restricted in movements at least in the downward direction (Z-direction), the longitudinal direction (Y-direction), and the lateral direction (X-direction) of the cleaning blade 400 by the insertion protrusions 81a and 81b, even when the cleaning blades 400 move due to transportation or the like, the cleaning blades 400 do not drop off the packaging member 5. Notably, as will be described in detail later herein, if the upward movement of the cleaning blade 400 must be restricted, a packaging member 5A consisting of another set of packaging member main bodies (a second packaging member main body 5c and a second packaging member main body 5d) may be stacked on the packaging member 5 (see FIG. 20).

The packaging member 5 consisting of the first packaging member main body 5a and the first packaging member main body 5b can package eight cleaning blades 400 at a time by means of the eight insertion protrusions 81a and the eight insertion protrusions 81b provided on the respective packaging member main bodies, whereby storage rate and work efficiency can be increased. Therefore, the packaging member 5 also can yield effects similar to those of the packaging member 2.

The first packaging member main body 5a has a vertically (Z-direction) stackable structure. Specifically, a lower surface 84a of the first packaging member main body 5a has a groove 85a extending along the longitudinal direction (X-direction), and a groove 87a formed in an end portion 86a located at the other end in the longitudinal direction such that the groove 87a extends along the lateral direction (Y-direction).

The groove 85a of the first packaging member main body 5a is longer in length along the longitudinal direction (X-direction) than the row of the insertion protrusions 81a disposed on the upper surface 80a at fixed intervals. The width of the groove 85a along the lateral direction (Y-direction) is greater than the diameter of the insertion protrusion 81a. Further, the depth (Z-direction) of the groove 85a is greater than the height of the insertion protrusion 81a.

According to embodiment 5, as a result of employment of such a structure of the groove 85a, when the packaging member 5A is stacked on the packaging member 5 (see FIG. 20), all of the insertion protrusions 81a and 81b formed on the upper surfaces 80a and 80b of the first packaging member main bodies 5a and 5b can be received in the grooves 85c and 85d of the second packaging member main bodies 5c and 5d, respectively. Further, the formation of the groove 85a reduces the weight of the first packaging member main body 5a.

According to embodiment 5, when the packaging member 5 and the packaging member 5A are stacked while the holes 407 and 406 of the opposite end portions 405 and 404 of the holder parts 402 are fitted to the insertion protrusions 81a and 81b of the first packaging member main bodies 5a and 5b (see FIG. 19), respectively, lower surfaces 84c and 84d of the second packaging member main bodies 5c and 5d press the opposite end portions 405 and 404. As a result, upward (Z-direction) movements of the cleaning blades 400 are restricted. Therefore, the packaging member 5 also can yield effects similar to those of the packaging member 2.

According to embodiment 5, by virtue of the groove 87a formed orthogonally to the groove 85a in the lower surface 84a of the first packaging member main body 5a, the weight of the first packaging member main body 5a can be reduced, and positioning of the first packaging member main body 5a can be facilitated.

### [2. Mode of Use of Packaging Member for Cleaning Blades]

Next, a mode of use of the packaging member 5 will be described. As shown in FIG. 18, first, the first packaging member main bodies 5a and 5b and eight cleaning blades 400 are prepared. Next, the hole 407 of the holder part 402 of the first cleaning blade 400 is fitted to the insertion protrusion 81a of the first packaging member main body 5a. Similarly, the hole 406 of the holder part 402 is fitted to the insertion protrusion 81b of the first packaging member main body 5b, thereby supporting the opposite end portions 405 and 404 by the insertion protrusions 81a and 81b, respectively. As a result, the first cleaning blade 400 is stored in the space between the first packaging member main body 5a and the first packaging member main body 5b.

Next, similar to the case of the first cleaning blade 400, the opposite end portions 405 and 404 of the second to eighth cleaning blades 400 are supported by the respective insertion protrusions 81a and 81b. As a result, all of the second to eighth cleaning blades 400 are stored in the space between the first packaging member main body 5a and the first packaging member main body 5b, thereby completing packaging of the cleaning blades 400 in the first-level packaging member 5.

Next, as shown in FIG. 20, the second packaging member main bodies 5c and 5d and eight cleaning blades 400 are prepared, and the second packaging member main bodies 5c and 5d are stacked on the first packaging member main bodies 5a and 5b, respectively. Then, similar to the case of the packaging member 5, all of the cleaning blades 400 are stored in the space between the second packaging member main body 5c and the second packaging member main body 5d, thereby completing packaging of the cleaning blades 400 in the second-level packaging member 5A.

Next, a packaging member 5B consisting of another set of packaging member main bodies (a third packaging member main body 5e and a third packaging member main body 5f) and eight cleaning blades 400 are prepared. Then, similar to the case of the packaging member 5A, the packaging member 5B is stacked on the packaging member 5A, and all of the cleaning blades 400 are stored in the space between the third packaging member main body 5e and the third packaging member main body 5f, thereby completing packaging of the cleaning blades 400 in the third-level packaging member 5B.

By sequentially stacking the packaging member 5, the packaging member 5A, and the packaging member 5B as mentioned above, embodiment 5 can yield effects similar to those of embodiment 2 in which the packaging member 2, the packaging member 2A, and the packaging member 2B are stacked together.

As shown in FIG. 21, similar to the case of embodiment 2, as a result of the first packaging member main body 5a having a vertically (Z-direction) stackable structure, embodiment 5 can restrict movement of the cleaning blade 400 in the upward direction (Z-direction) in addition to movements of the cleaning blade 400 in the downward direction (Z-direction), the longitudinal direction (Y-direction), and the lateral direction (Z-direction). That is, the end portions 405 of the cleaning blades 400 positioned by the insertion protrusions 81a (see FIG. 19) of the first packaging member main body 5a are pressed by the lower surface 84c of the overlying second packaging member main body 5c, whereby the posture of the cleaning blades 400 is further firmly held. Thus, even when the cleaning blades 400 move due to transportation or the like, the cleaning blades 400 do not come into contact with other cleaning blades 400, thereby avoiding mutual interference of the cleaning blades 400. As a result, according to embodiment 5, even though the packaging member 5, the packaging member 5A, and the packaging member 5B are stacked together, the occurrence of deformation, breakage, etc., of the cleaning blades 400 can be prevented.

### Embodiment 6

[1. Packaging Member for cleaning Blades]

First, a packaging member according to a sixth embodiment (hereinafter, called “embodiment 6”) of the present invention will be described. Since a packaging member 6 (see FIG. 23) is a modified embodiment of the packaging member 5 and is configured similarly to the packaging member 5 except for a structure of supporting opposite ends of the cleaning blade, the packaging member 6 can yield all of excellent effects of the packaging member 5. Description of embodiment 6 covers only configurational features of the packaging member 6 different from those of the packaging member 5, and repeated description of other configurational features is omitted. In embodiment 6, a cleaning blade 500 (see FIG. 24) is applied.

Next, one first packaging member main body 6a and the other first packaging member main body 6b (see FIG. 23) which constitute the packaging member 6 will be described; however, since the first packaging member main bodies 6a and 6b are common members, description of the first packaging member main body 6b is omitted as appropriate. As shown in FIG. 22, the first packaging member main body 6a has eight insertion protrusions 92a protruding from one edge portion 91a (in the lateral direction (Y-direction)) of an upper surface 90a of the first packaging member main body 6a at fixed intervals along the longitudinal direction (X-direction) and also has eight insertion protrusions 94a protruding similarly from the other edge portion 93a of the upper surface 90a. The insertion protrusions 92a at the edge portion 91a and the insertion protrusions 94a at the edge portion 93a are formed at equal intervals in an aligned manner. The insertion protrusions 92a and 94a have respective approximately circular columnar shapes having different diameters and allow holes 506 and 507 formed in opposite end portions 504 and 505 of a holder part 502 to be fitted respectively thereto (see FIG. 24).

In the first packaging member main body 6a, when the end portion 504 of the holder part 502 is placed on the edge portion 91a while the hole 506 of the holder part 502 is fitted to the insertion protrusion 92a, the periphery of a lower end portion 95a of the insertion protrusion 92a serves as a rest portion 96a for supporting the end portion 504. Similarly, the periphery of a lower end portion 97a of the insertion protrusion 94a serves as a rest portion 98a for supporting the end portion 505.

According to embodiment 6, when the hole 506 of the end portion 504 of the holder part 502 is fitted to the insertion protrusion 92a of the first packaging member main body 6a, the rest portion 96a comes into contact with and supports the end portion 504. At this time, the end portion 504 of the holder part 502 is positioned in a predetermined posture and held in the positioned condition by the insertion protrusion 92a. Similarly, when the hole 507 of the end portion 505 is fitted to an insertion protrusion 94a to thereby be positioned, the cleaning blade 500 is held in the space between the first packaging member main body 6a and the first packaging member main body 6b.

As a result, since the cleaning blade 500 is restricted in movements at least in the downward direction (Z-direction), the longitudinal direction (Y-direction), and the lateral direction (X-direction) of the cleaning blade 500, even when the cleaning blades 500 move due to transportation or the like, the cleaning blades 500 do not drop off the packaging member 6. Notably, as will be described in detail later herein, if the upward movement of the cleaning blade 500 must be restricted, a packaging member 6A consisting of another set of packaging member main bodies (a second packaging member main body 6c and a second packaging member main body 6d) may be stacked on the packaging member 6 (see FIG. 23).

The packaging member 6 consisting of the first packaging member main body 6a and the first packaging member main body 6b can package eight cleaning blades 500 at a time by means of the eight insertion protrusions 92a and the eight insertion protrusions 94b provided on the respective packaging member main bodies, whereby storage rate and work efficiency can be increased. Therefore, the packaging member 6 also can yield effects similar to those of the packaging member 5.

Similar to the case of the first packaging member main body 5a, the first packaging member main body 6a has a vertically (Z-direction) stackable structure. Specifically, the first packaging member main body 6a has a groove 101a formed in one end portion 100a (in the lateral direction (Y-direction)) of a lower surface 99a of the first packaging member main body 6a such that the groove 101a extends along the longitudinal direction (X-direction) and has a groove 103a similarly formed in the other end portion 102a.

The groove 101a of the first packaging member main body 6a is longer in length along the longitudinal direction than the row of the insertion protrusions 92a disposed at fixed intervals. The width of the groove 101a along the lateral direction is greater than the diameter of the insertion protrusion 92a. Further, the depth of the groove 101a is greater than the height of the insertion protrusion 92a. Similarly, the length along the longitudinal direction, the width along the lateral direction, and the depth of the groove 103a of the first packaging member main body 6a are determined on the basis of the length of the row, the diameter, and the height, respectively, of the insertion protrusions 94a of the first packaging member main body 6a.

According to embodiment 6, as a result of employment of such structures of the grooves 101a and 103a, when the packaging member 6A is stacked on the packaging member 6, all of the insertion protrusions 92a, 94a, 92b, and 94b formed on the upper surfaces 90a and 90b of the first packaging member main bodies 6a and 6b can be received in the grooves 101c, 103c, 101d, and 103d of the second packaging member main bodies 6c and 6d, respectively.

According to embodiment 6, when the packaging member 6 and the packaging member 6A are stacked while the holes 507 and 506 of the opposite end portions 505 and 504 of the holder parts 502 are fitted to the insertion protrusions 94a and 92b of the first packaging member main bodies 6a and 6b (see FIG. 23), respectively, lower surfaces 99c and 99d of the second packaging member main bodies 6c and 6d press the opposite end portions 505 and 504. As a result, upward (Z-direction) movements of the cleaning blades 500 are restricted. Therefore, the packaging member 6 also can yield effects similar to those of the packaging member 5.

According to embodiment 6, the first packaging member main body 6a has a groove 106a formed in the upper surface 90a between the row of the insertion protrusions 92a and the row of the insertion protrusions 94a formed on the upper surface 90a, and extending along the longitudinal direction (X-direction) to opposite end portions 104a and 105a. By virtue of the groove 106a formed in the upper surface 90a of the first packaging member main body 6a, the weight of the first packaging member main body 6a can be reduced.

According to embodiment 6, the first packaging member main body 6a has a groove 108a formed in the lower surface 99a of the first packaging member main body 6a at one longitudinal end portion 107a such that the groove 108a extends orthogonally to the grooves 101a and 103a. By virtue of formation of the groove 108a in the lower surface 99a of the first packaging member main body 6a, the weight of the first packaging member main body 6a can be reduced, and positioning of the first packaging member main body 6a can be facilitated.

### [2. Mode of Use of Packaging Member for Cleaning Blades]

Next, a mode of use of the packaging member 6 will be described. As shown in FIGS. 22 and 23, first, the first packaging member main bodies 6a and 6b and eight cleaning blades 500 are prepared. Next, the hole 507 of the holder part 502 of the first cleaning blade 500 is fitted to the insertion protrusion 94a of the first packaging member main body 6a. Similarly, the hole 506 of the holder part 502 is fitted to the insertion protrusion 92b of the first packaging member main body 6b, thereby supporting the opposite end portions 505 and 504 by the insertion protrusions 94a and 92b, respectively. As a result, the first cleaning blade 500 is stored in the space between the first packaging member main body 6a and the first packaging member main body 6b.

Next, similar to the case of the first cleaning blade 500, the opposite end portions 505 and 504 of the second to eighth cleaning blades 500 are supported by the respective insertion protrusions 94a and 92b. As a result, all of the second to eighth cleaning blades 500 are stored in the space between the first packaging member main body 6a and the first packaging member main body 6b, thereby completing packaging of the cleaning blades 500 in the first-level packaging member 6.

Next, the second packaging member main bodies 6c and 6d and eight cleaning blades 500 are prepared. First, the packaging member 6A is stacked on the packaging member 6 while the insertion protrusions 92a, 94a, 92b, and 94b of the first packaging member main bodies 6a and 6b are received respectively in the grooves 101c, 103c, 101d, and 103d of the second packaging member main bodies 6c and 6d. Next, similar to the case of the packaging member 6, the opposite end portions 505 and 504 of all of the cleaning blades 500 are supported by the insertion protrusions 94c and 92d of the second packaging member main bodies 6c and 6d. As a result, all of the cleaning blades 500 are stored in the space between the second packaging member main body 6c and the second packaging member main body 6d, thereby completing packaging of the cleaning blades 500 in the second-level packaging member 6A.

Next, a packaging member 6B consisting of another set of packaging member main bodies (a third packaging member main body 6e and a third packaging member main body 6f), and eight cleaning blades 500 are prepared. Next, similar to the case of the packaging member 6A, the packaging member 6B is stacked on the packaging member 6A, and all of the cleaning blades 500 are stored in the space between the third packaging member main body 6e and the third packaging member main body 6f, thereby completing packaging of the cleaning blades 500 in the third-level packaging member 6B.

By sequentially stacking the packaging member 6, the packaging member 6A, and the packaging member 6B as mentioned above, embodiment 6 can yield effects similar to those of embodiment 5 in which the packaging member 5, the packaging member 5A, and the packaging member 5B are stacked together.

### [3. Cleaning Blade]

Next, a cleaning blade applicable to the packaging member 6 will be described. The present cleaning blade can also be applied to other embodiments.

As shown in FIG. 24, similar to the cleaning blades 300 and 400, the cleaning blade 500 includes a blade main body 501 and the holder part 502. The holder part 502 is bonded through an adhesive (not shown) to one lateral end portion 503 of the blade main body 501. The shape and material of the blade body 501 and the material of the holder part 502 can be similar to those of the cleaning blades 300 and 400.

Similar to the cleaning blades 300 and 400, the longitudinal opposite end portions 504 and 505 of the holder part 502 have holes 506 and 507 formed therein. The holes 506 and 507 differ in diameter such that the diameter of the hole 507 is greater than the diameter of the hole 506. The cleaning blade 500 does not have the protrusions 308 and 309 formed on the cleaning blade 300.

### Embodiment 7

First, a packaging member according to a seventh embodiment (hereinafter, called “embodiment 7”) of the present invention will be described. Since the present packaging member is a modified embodiment of the packaging member 6 of embodiment 6 and is configured similarly to the packaging member 6 except for a structure of supporting the cleaning blades, the present packaging member can yield all of excellent effects of the packaging member 6. Description of embodiment 7 covers only configurational features of the present packaging member different from those of the packaging member 6, and repeated description of other configurational features is omitted. Similar to the case of embodiment 6, in embodiment 7, the cleaning blade 500 (see FIG. 24) is applied.

Next, one first packaging member main body 7a and the other first packaging member main body 7b which constitute the present packaging member will be described; however, since the first packaging member main bodies 7a and 7b are common members, description of the first packaging member main body 7b is omitted as appropriate. As shown in FIG. 25, the first packaging member main body 7a has eight rest recesses 112a formed in one edge portion 111a (in the lateral direction (Y-direction)) of an upper surface 110a of the first packaging member main body 7a at fixed intervals along the longitudinal direction (X-direction) and has insertion protrusions 113a protruding from the respective rest recesses 112a. Similarly, the first packaging member main body 7a also has eight rest recesses 115a formed in the other edge portion 114a and has insertion protrusions 116a protruding from the respective rest recesses 115a. The rest recesses 112a and the rest recesses 115a are formed at equal intervals in an aligned manner, and the insertion protrusions 113a and the insertion protrusions 116a are also formed at equal intervals in an aligned manner.

Similar to the insertion protrusions 92a and 94a (see FIG. 22) of the first packaging member main body 6a, the insertion protrusion 113a protruding from the rest recess 112a and the insertion protrusion 116a protruding from the rest recess 115a have respective approximately circular columnar shapes having different diameters. The insertion protrusion 113a and the insertion protrusion 116a allow the holes 506 and 507 formed in longitudinal opposite end portions 504 and 505 of the holder part 502 of the cleaning blade 500 to be fitted respectively thereto.

In packaging the cleaning blade 500 by use of the first packaging member main bodies 7a and 7b, the hole 507 of the holder part 502 is fitted to the insertion protrusion 116a of the first packaging member main body 7a, whereby the rest recess 115a comes into contact with and supports the end portion 505. Similarly, the hole 506 of the holder part 502 is fitted to the insertion protrusion 113b of the first packaging member main body 7b, whereby the rest recess 112b comes into contact with and supports the end portion 504.

At this time, the end portion 505 of the holder part 502 is positioned in a predetermined posture and held in the positioned condition by the insertion protrusion 116a; similarly, the end portion 504 of the holder part 502 is positioned in a predetermined posture and held in the positioned condition by the insertion protrusion 113b. According to embodiment 7, when the opposite end portions 505 and 504 of the holder part 502 are positioned by the insertion protrusions 116a and 113b, the cleaning blade 500 is held in the space between the first packaging member main body 7a and the first packaging member main body 7b.

Therefore, similar to the case of embodiment 6, since the cleaning blade 500 is packaged in such a condition that movements at least in the downward direction (Z-direction), the longitudinal direction (Y-direction), and the lateral direction (X-direction) of the cleaning blade 500 are restricted, even when the cleaning blades 500 move due to transportation or the like, the cleaning blades 500 do not drop off the packaging member consisting of the first packaging member main bodies 7a and 7b.

By virtue of the first packaging member main body 7a having the rest recesses 112a and 115a formed in laterally (Y-direction) opposite edge portions 111a and 114a, respectively, in vertically stacking the packaging members each consisting of the first packaging member main bodies 7a and 7b, the overlying packaging member does not press the opposite end portions 504 and 505 of the holder parts 502, whereby the occurrence of deformation, breakage, etc., of the cleaning blades 500 can be prevented.

Specifically, according to embodiment 7, in stacking the packaging member consisting of the first packaging member main bodies 7a and 7b, and the packaging member consisting of another set of packaging member main bodies, the holes 507 and 506 of the holder parts 502 are fitted to the insertion protrusions 116a an 113b of the first packaging member main bodies 7a and 7b, respectively, whereby the opposite end portions 505 and 504 are received by the rest recesses 115a and 112b, respectively. Since the rest recesses 115a and 112b of the first packaging member main bodies 7a and 7b are lower in level in the thickness direction (Z-direction) than the upper surfaces 110a and 110b, respectively, the opposite end portions 505 and 504 are completely stored in the rest recesses 115a and 112b, respectively.

Therefore, according to embodiment 7, since the lower surfaces of the another set of packaging member main bodies do not come into contact with the opposite end portions 504 and 505 of the holder parts 502, upward (Z-direction) movements of the cleaning blades 500 can be restricted by vertically stacking the packaging members each consisting of the first packaging member main bodies 7a and 7b without involvement of deterioration of the opposite end portions 504 and 505.

Similar to the case of the first packaging member main body 6a, the first packaging member main body 7a has a groove 119a formed in the upper surface 110a of the first packaging member main body 7a and extending along the longitudinal direction (X-direction) to opposite end portions 117a and 118a and has a groove 121a formed in a lower surface 120a of the first packaging member main body 7a at the longitudinal end portion 117a such that the groove 121a extends orthogonally to two grooves (not shown). According to embodiment 7, by virtue of formation of such grooves, the weight of the first packaging member main body 7a can be reduced. Similar to the case of the first packaging member main body 6a, the two grooves (not shown) formed in the lower surface 120a serve as storage parts for the insertion protrusions 113a and 116a in vertically (Z-direction) stacking the first packaging member main bodies 7a, and the groove 121a serves as a mark in positioning the first packaging member main body 7a.

### (Modified Embodiments of Packaging Member for Cleaning Blades)

The present invention does not limit material for the packaging member main body to a hard resin, and the material can be appropriately selected as needed, so long as deformation, breakage, etc., of the packaging member main body in packaging work, transportation, etc., can be prevented.

Also, the present invention does not impose particular limitation on the shape of the packaging member main body, and the shape can be appropriately modified as needed, so long as the shape is suited for packaging the cleaning blades. In the present invention, in view of cost performance, preferably, constituent elements, such as engagement protrusions and insertion protrusions, of the packaging member main bodies are also of the same materials as those of the packaging member main bodies.

The present invention allows modification, as appropriate, of the shapes, positions, numbers, sizes, etc., of the constituent elements of the packaging member main bodies to be modified as appropriate in accordance with the cleaning blades. Notably, the constituent elements of the packaging member main bodies are the support parts, the engagement protrusions, the engagement recesses, the recesses, the insertion protrusions, the rest portions, the grooves, the side recesses, the rest recesses, etc.

For example, the lower surface, the opposite side walls, and the recess wall which constitute the support part, and the upper surface, the opposite side walls, and the recess wall which constitute the engagement recess may be flat or may be, for example, a special surface on which an inclined surface, a protrusion, etc. are formed in accordance with the shape of the cleaning blade to be packaged.

The shapes of constituent surfaces of each support part are not particularly limited, but can be appropriately modified as needed, so long as the support part can support the holder part of the cleaning blade at at least three points so as to hold the cleaning blade in a predetermined posture through reception of the holder part therein.

Similar to the case of the support part, the shapes of constituent surfaces of each engagement recess are not particularly limited, so long as the engagement recess can hold the posture of the cleaning blade received by the support part and further can restrict an upward movement of the cleaning blade. For example, the position of the upper surface in the thickness direction of the packaging member main body may be changed or may be determined such that the upper surface comes into contact with the upper edge portion of the holder part.

In the present invention, in the case where a set of packaging member main bodies are used for packaging the cleaning blades in a flat placement condition, another set of packaging member main bodies to be stacked thereon may have grooves formed respectively in the lower surfaces for restricting lateral movements of the cleaning blades. Employment of such grooves avoids mutual interference of the cleaning blades, whereby the occurrence of deformation, breakage, etc., of the cleaning blades can be prevented.

Alternatively, in order to prevent the occurrence of deformation, breakage, etc., of the cleaning blades, the present invention may employ a set of packaging member main bodies which store no cleaning blades and which are stacked at the top level for restricting upward movements of the cleaning blades in the lower level.

The present invention can be applied to cleaning blades other than the cleaning blades 300, 400, and 500 mentioned above, and modifications of the cleaning blades are acceptable without departing from the gist of the invention. The present invention can be applied to, for example, asymmetrical or symmetrical cleaning blades. An asymmetrical cleaning blade has a holder part whose opposite end portions differ in form, such as a cleaning blade 600 shown in FIG. 26 in which opposite end portions 604 and 605 of a holder part 602 differ in form. Specifically, a length L1 between one longitudinal end 612 of a blade main body 601 and one longitudinal end 613 of the holder part 602 and a length L2 between then other longitudinal end 614 of the blade main body 601 and the other longitudinal end 615 of the holder part 602 differ from each other. In the cleaning blade 600, holes 606 and 607 formed in the opposite end portions 604 and 605, respectively, of the holder part 602 differ in shape in plan view; however, the holes 606 and 607 may have the same diameter, the same shape in plan view, or the like. Examples of a symmetrical cleaning blade include, for example, the cleaning blades 300, 400, and 500 mentioned above.

### INDUSTRIAL APPLICABILITY

The packaging member for cleaning blades according to the present invention is preferred for packaging the cleaning blades for use in image forming apparatus, such as electrophotographic copiers and printers and toner-jet copiers and printers, for transportation or the like of the cleaning blades.

### DESCRIPTION OF REFERENCE NUMERALS

1, 2, 2A, 2B, 3, 3A, 3B, 4, 4A, 4B, 5, 5A, 5B, 6: packaging member
1a, 1b, 2a, 2b, 3a, 3b, 4a, 4b, 5a, 5b: first packaging member main body
2c, 2d, 3c, 3d, 4c, 4d, 5c, 5d, 6c, 6d: second packaging member main body
2e, 2f, 3e, 3f, 4e, 4f, 5e, 5f, 6e, 6f: third packaging member main body
10a, 20a, 26a, 40a, 50a, 80a, 90a, 110a: upper surface
11a, 21a, 24a, 41a, 48a, 58a, 64a, 91a, 93a: edge portion
12a, 12b, 22a, 42a, 59a, 59b, 59c, 74a: support part
13a, 23a, 43a, 47a, 84a, 99a, 120a: lower surface
14a, 15a, 27a, 28a, 44a, 45a, 51a, 52a: side wall
16a, 29a, 29c, 29e, 46a, 53a, 63a, 69a: recess wall
30a, 31a, 54a, 55a, 58a, 72a, 77a, 86a: end portion
32a, 32b, 32c, 32d, 56a: engagement protrusion
33a, 33c, 33d, 33e, 33f, 57a: engagement recess
25a, 25c, 25e, 49a, 65a, 75a: recess
81a, 81b, 92a, 92b, 92d, 94a, 94b, 94c: insertion protrusion
82a, 95a, 97a: lower end portion
83a, 96a, 98a: rest portion
85a, 85c, 85d, 87a, 101a, 101c, 101d, 103a: groove
70a, 71a: side surface
73a, 76a, 78a: side recess
112a, 112b, 115a: rest recess
300, 400, 500, 600: cleaning blade
301, 401, 501, 601: blade main body
302, 402, 502, 602: holder part
303, 304, 305, 404, 405, 504, 505, 604, 605: end portion
306, 307, 406, 407, 506, 507, 606, 607: hole
308, 309: protrusion
310: lower edge portion
311: upper edge portion
312, 314, 612, 613, 614, 615: longitudinal end
316, 317, 318, 319: side surface

1. A packaging member for cleaning blades, each having a blade body, which is brought into slide contact with a surface of a latent image carrier, and a holder part for supporting a non-slide-contact portion of the blade body, the packaging member comprising:
at least a set of packaging member main bodies for supporting opposite end portions of the holder parts of the cleaning blades,
the packaging member being characterized in that
a first packaging member main body of the set of packaging member main bodies has a plurality of first support parts disposed at predetermined intervals along a longitudinal direction thereof and adapted to support respective one end portions of the holder parts, and
a second packaging member main body of the set of packaging member main bodies has a plurality of second support parts disposed at predetermined intervals along the longitudinal direction thereof and adapted to support respective other end portions of the holder parts,
wherein each of the first packaging member main body and the second packaging member main body has engagement portions at respective longitudinal opposite end portions for allowing stacking in the vertical direction, and each of the engagement portions has an engagement protrusion formed on an upper surface thereof and has an engagement recess formed in a lower surface thereof for engagement with the engagement protrusion, and
each of the first packaging member main body and the second packaging member main body has recesses formed in a lower surface thereof for avoiding interference with the holder parts of the cleaning blades supported by the first support parts and the second support parts.

2. The packaging member for cleaning blades according to claim 1, wherein the first packaging member main body and the second packaging member main body are common members, and each of the first packaging member main body and the second packaging member main body has the first support parts or the second support parts disposed at one edge portion in a lateral direction orthogonal to the longitudinal direction and has the first support parts or the second support parts disposed at the other edge portion in the lateral direction.

3. The packaging member for cleaning blades according to claim 1, wherein each of the first support parts and the second support parts has a lower surface, opposite side walls, and a recess wall, the opposite side walls and the recess wall being restricted in movements at least in a downward direction, a longitudinal direction, and a lateral direction.

4. The packaging member for cleaning blades according to claim 1, wherein the first support parts and the second support parts are grooves.

5. The packaging member for cleaning blades according to claim 1, wherein:
each of the holder parts has holes extending therethrough in a thickness direction thereof and formed at respective opposite end portions thereof, and
the first support parts and the second support parts have respective insertion protrusions which are inserted into the holes.

6. The packaging member for cleaning blades according to claim 1, wherein each of the first packaging member main body and the second packaging member main body has engagement portions at respective longitudinal opposite end portions for allowing stacking in the vertical direction, and each of the engagement portions has an engagement protrusion formed on an upper surface thereof and has an engagement recess formed in a lower surface thereof for engagement with the engagement protrusion.

7. The packaging member for cleaning blades according to claim 1, further comprising:
a first packaging member consisting of the set of packaging member main bodies; and
a second packaging member to be stacked on the first packaging member and consisting of another set of packaging member main bodies,
wherein longitudinal positions of the first support parts and the second support parts of the first packaging member differ from longitudinal positions of the support parts of the second packaging member.

8. The packaging member for cleaning blades according to claim 1,
wherein the first packaging member main body has a plurality of first support parts disposed in one edge portion in the lateral direction of the first packaging member main body, and has a plurality of second support parts disposed in another edge portion in the lateral direction of the first packaging member main body, and
wherein the second packaging member main body has a plurality of second support parts disposed in one edge portion in the lateral direction of the second packaging member main body, and has a plurality of first support parts disposed in another edge portion in the lateral direction of the second packaging member main body.
